(19) United States
(12) Patent Application Publication
(10) Pub. No.: US 2026/0071518 A1
(43) Pub. Date: Mar. 12, 2026

(54) SURFACTANT FOR CARBON DIOXIDE STORAGE

(71) Applicants: TOTALENERGIES ONETECH, Courbevoie (FR); ECOLE SUPERIEURE DE PHYSIQUE ET DE CHIMIE INDUSTRIELLES DE LA VILLE DE PARIS, Paris (FR); SORBONNE UNIVERSITE, Paris (FR); CENTRE NATIONAL DE LA RECHERCHE SCIENTIFIQUE, Paris (FR)

(72) Inventors: Alexandra KLIMENKO, Pau (FR); Christophe BLONDEAU, Pau (FR); Michèle JOLY, Pau (FR); Lei DING, Pau (FR)

(21) Appl. No.: 19/107,537

(22) PCT Filed: Aug. 30, 2022
(86) PCT No.: PCT/IB2022/000501

§ 371 Date: Feb. 27, 2025

(51) Int. Cl. E21B 41/00; E21B 43/00

(52) U.S. Cl. CPC E21B 41/0064; E21B 43/00

(57) ABSTRACT

The invention relates to a method of storing carbon dioxide in a subterranean formation not containing any hydrocarbons, comprising injecting a surfactant into the subterranean formation, injecting carbon dioxide into the subterranean formation, wherein the surfactant is a compound of formula (I), wherein R₁, R₂, R₃, and R₅ are independently a hydrogen atom or an alkyl group, A is an alkylene group, and the total number of carbon atoms in the surfactant compound of formula (I) is from 10 to 24.

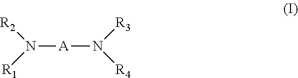

### TECHNICAL FIELD

The present invention relates to the use of surfactant compounds in storing carbon dioxide in a subterranean formation which does not contain any hydrocarbons.

### TECHNICAL BACKGROUND

The anthropogenic release of carbon dioxide has a serious impact on the global carbon cycle. The accumulation of carbon dioxide in the atmosphere results in, for example, a reduction in the pH of the ocean. As a well-known greenhouse gas, its atmospheric accumulation also raises concern about climate change and global warming.

The long-term storage of anthropogenic carbon dioxide (also known as carbon dioxide sequestration) has been developed in order to limit its atmospheric accumulation. Injection of carbon dioxide into a geological formation (a porous medium, e.g., water-bearing subterranean formation such as an aquifer) is one option to store carbon dioxide. However, the injection of carbon dioxide into such a formation is an unstable process due to the lower viscosity of carbon dioxide compared to water viscosity: carbon dioxide migrates away from the injection well, creating a carbon dioxide “plume” (volume occupied by gas, liquid or supercritical carbon dioxide undissolved in water) which can rise to the top parts of the formation due to the gravity override. The relatively low viscosity of carbon dioxide also causes viscous fingering and less effective displacement of water. Moreover, in the presence of the cap rock/fault geomechanical defect, which creates a flow path, or in the absence of the capillary barrier, “free” CO₂ can leak into the atmosphere due to the difference in density with respect to water.

Mitigation of these issues can be achieved by the addition of a surfactant to generate carbon dioxide/water emulsions (sometimes also referred to as “foams”). Generally, emulsions have a relatively high viscosity. Thus, the generation of such carbon dioxide emulsion makes it possible to stabilize the carbon dioxide front. Specifically, the viscous phase (carbon dioxide emulsion) replaces the low-viscosity phase (e.g., water present in the formation) by a “piston-like” mechanism which either increases/accelerates the carbon dioxide storage at a given injection zone (licensed area, exploitation zone) or reduces the extension of the carbon dioxide plume so as to remain far from some critical areas (such as areas with unsealing or reactivable faults, existing wells with integrity issue, etc.) or to stay within the storage limits, while ensuring that the geomechanical constraints due to the pressure increase during injection are respected.

However, the selection of appropriate surfactants is difficult. Non-ionic surfactants tend not to be poorly soluble in brine at high temperature and high salinity conditions. Non-ionic surfactants generally cause adsorption issues on minerals, too. Cationic and anionic surfactants tend to have a low solubility in carbon dioxide and also cause adsorption issues on minerals (e.g., on sand stones for a cationic surfactant and on carbonates for an anionic surfactant).

The article entitled “Carbon Dioxide-in-Water Foams Stabilized with a Mixture of Nanoparticles and Surfactant for carbon dioxide Storage and Utilization Applications” by Andrew Jay Worthen et al., Energy Procedia 6; 7929-7938 (2014) discloses synergistic interactions between surface-modified nanoparticles and surfactants for stabilizing carbon dioxide foams at elevated temperature and pressure typical of subsurface formations for enhanced oil recovery or geologic storage of carbon dioxide.

The article entitled “Increased CO₂ storage capacity using CO₂-foam” by T. Føyen et al., Int. J. Greenh. Gas Control 96; 103016 (2020) investigates six surfactants with a different range of solubility in carbon dioxide for generating a CO₂ foam and reducing the carbon dioxide mobility.

The article entitled “CO₂ mobility reduction using foam stabilized by CO₂- and water-soluble surfactants” by T. Føyen et al., J. Pet. Sci. Eng. 196; 107651 (2021) discloses the use of aqueous- and CO₂-soluble surfactants for generating and stabilizing CO₂ foams under the subsurface geological formation conditions.

However, the surfactants used in the above articles are not suitable at a high temperature and a high salinity due to, for example, their poor solubility in a brine (leading to the precipitation and loss of the surfactant) and, when injected in CO₂, uneven partition into the brine, leading to the consumption of the surfactant along the displacement.

The article entitled “Effect of Surfactant Partitioning between Gaseous Phase and Aqueous Phase on CO₂ Foam Transport for Enhanced Oil Recovery” by Yongchao Zeng et al., Transp Porous Med 114, 777-793 (2006) develops a 1-D foam simulator and demonstrates that, when the surfactant partitions approximately equally between gaseous phase and aqueous phase, foam favors oil displacement in regard with apparent viscosity and foam propagation speed.

The article entitled “A Novel Foam Concept with CO₂ Dissolved Surfactants” by Viet Q. Le et al., with the reference SPE-113370-MS (2008) proposes an injection strategy which involves dissolving a surfactant in carbon dioxide, and shows that CO₂-dissolved surfactants greatly reduce the mobility of the injected gas, thereby lowering the injection costs, reducing the loss of surfactant onto the rock surface due to adsorption, and improving in-situ foam generation to significantly increase oil recovery.

Patent application WO 2018/146107 discloses a composition comprising liquid or supercritical carbon dioxide and at least one surfactant compound, and a method of injecting the surfactant composition into a subterranean formation for extracting hydrocarbons from the subterranean formation.

The above surfactants are not fully satisfactory, especially for a water-bearing subterranean formation (which can be highly saline) which does not contain hydrocarbons. There is still a need for surfactants which provide higher efficiency in carbon dioxide storage in such a subterranean formation.

### SUMMARY OF THE INVENTION

It is a first object of the invention to provide a method of storing carbon dioxide in a subterranean formation not containing any hydrocarbons, comprising:
injecting a surfactant into the subterranean formation;
injecting carbon dioxide into the subterranean formation;
wherein the surfactant is a compound of formula (I):

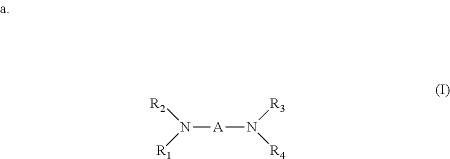

wherein R₁, R₂, R₃, and R₄ are independently a hydrogen atom or an alkyl group, A is an alkylene group, and the total number of carbon atoms in the surfactant compound of formula (I) is from 10 to 24.

According to some embodiments, the surfactant and the carbon dioxide are injected simultaneously.

According to some embodiments, the method further comprises a step of premixing the surfactant and the carbon dioxide to make a CO₂-surfactant composition, and comprises injecting the CO₂-surfactant composition into the subterranean formation.

According to some embodiments, the method comprises a step of injecting carbon dioxide without surfactant into the subterranean formation after the step of injecting the COₑ-surfactant composition into the subterranean formation.

According to some embodiments, no water is injected into the subterranean formation.

According to some embodiments, the surfactant and the carbon dioxide are injected separately.

According to some embodiments, the method further comprises a step of injecting water into the subterranean formation.

According to some embodiments, the carbon dioxide and the water are injected simultaneously.

According to some embodiments, the carbon dioxide and the water are injected separately.

According to some embodiments, the carbon dioxide and the water are injected alternately.

According to some embodiments, the method further comprises a step of premixing the surfactant, the carbon dioxide, and the water to make a CO₂-surfactant-water composition, and comprises injecting this CO₂-surfactant-water composition into the subterranean formation.

According to some embodiments, the method further comprises a step of premixing the surfactant and the carbon dioxide to make a CO₂-surfactant composition and comprises injecting this CO₂-surfactant composition into the subterranean formation.

According to some embodiments, the step of injecting the CO₂-surfactant composition and the step of injecting the water are carried out alternately.

According to some embodiments, the method further comprises a step of premixing the surfactant and water to make a surfactant-water composition and injecting the surfactant-water composition into the subterranean formation.

According to some embodiments, the step of injecting the carbon dioxide and the step of injecting the surfactant-water composition are carried out alternately.

According to some embodiments, the carbon dioxide is liquid or supercritical carbon dioxide.

According to some embodiments, the injecting step(s) is/are carried out via at least one injection well.

According to some embodiments, the injection well comprises a pipeline for injecting the surfactant, the pipeline being connected to a dosimetric pump.

According to some embodiments, the method further comprises a step of collecting water present in the subterranean formation, via at least one production well.

According to some embodiments, the production well(s) is/are located at a distance of from 1 to 100 km, preferably from 10 to 50 km, from at least one injection well via which the injecting step(s) is/are carried out.

According to some embodiments, the method does not comprise a step of collecting water present in the subterranean formation, via at least one production well.

According to some embodiments, the subterranean formation is an aquifer.

According to some embodiments, the total number of carbon atoms in the surfactant compound of formula (I) is from 12 to 23, preferably from 15 to 22, and more preferably from 17 to 20.

According to some embodiments, A comprises from 1 to 5 carbon atoms, preferably from 2 to 4 carbon atoms, and more preferably comprises 3 carbon atoms.

According to some embodiments, at least one of R₁, R₂, R₃ and R₄ is a hydrogen atom.

According to some embodiments, at least one of R₁, R₂, R₃ and R₄ is an alkyl group comprising from 8 to 16 carbon atoms, preferably from 10 to 15 carbon atoms, and more preferably from 12 to 14 carbon atoms.

According to some embodiments, R₁, R₂, R₃ and R₄ are independently selected from a hydrogen atom and linear alkyl groups.

According to some embodiments, at least one, and preferably two, of R₁, R₂, R₃ and R₄ is a methyl group.

According to some embodiments, A comprises 3 carbon atoms, R₁ is an alkyl group comprising from 6 to 16 carbon atoms, R₂ is a hydrogen atom, R₃ is a methyl group and R₄ is a methyl group.

According to some embodiments, wherein R₁ is an alkyl group comprising at least 8 carbon atoms, preferably from 10 to 16 carbon atoms, more preferably from 12 to 14 carbon atoms, and most preferably 12 carbon atoms.

According to some embodiments, the compound of formula (I) is selected from N¹-dodecyl-N³,N³-dimethylpropane-1,3-diamine, N¹-dodecyl-N¹,N³,N³-trimethylpropane-1,3-diamine, N¹-(2,2-diethyloctyl)-N³,N³-dimethylpropane-1,3-diamine, N¹-octyl-N³,N³-dimethylpropane-1,3-diamine, N¹-decyl-N³,N³-dimethylpropane-1,3-diamine, N¹-tetradecyl-N³,N³-dimethylpropane-1,3-diamine, N¹-hexadecyl-N¹,N³,N³-trimethylpropane-1,3-diamine, N¹-heptadecyl-N¹,N³,N³-trimethylpropane-1,3-diamine, N¹-octadecyl-N¹,N³,N³-trimethylpropane-1,3-diamine, and N-dodecyl-1,3-propanediamine.

According to some embodiments, the method further comprises a step of injecting at least one additional surfactant which is not according to formula (I), preferably selected from cationic and/or nonionic surfactants.

According to some embodiments, the concentration of the surfactant of formula (I) in the composition comprising the surfactant is from 500 to 50,000 ppm, preferably from 1,000 to 20,000 ppm (w/v).

The present invention makes it possible to overcome the drawbacks of the prior art. In particular, the present invention provides surfactant compounds which are suitable for storing carbon dioxide in a subterranean formation which does not contain any hydrocarbons.

The surfactant compounds of the present invention exhibit several properties useful in storing carbon dioxide in a subterranean formation which does not contain any hydrocarbons, such as a good chemical and thermal stability, good solubility in carbon dioxide and in water at a pressure, temperature and salinity typically encountered in a subterranean formation which does not contain any hydrocarbons, such as an aquifer, and a satisfactory partitioning coefficient between water and carbon dioxide.

Contrary to the enhanced oil recovery (EOR) method disclosed in the above-mentioned patent application WO 2018/146107, which aims at extracting hydrocarbons by injecting a surfactant composition into a subterranean formation, the present method relates to a method for storing carbon dioxide by injecting a surfactant compound of the present invention into a subterranean formation which does not contain any hydrocarbons. Furthermore, while the general EOR process, e.g., the method disclosed in the above WO 2018/146107, involves the back-production of a part of the injected CO₂, the present invention does not involve any back-production of the injected CO₂ because the injected CO₂ is meant to be stored in the subterranean formation permanently, thereby avoiding any cost for recycling.

Surprisingly, it has now been found that the surfactant compounds of the invention make it possible to achieve a high CO₂ saturation, which can be considered as an index of CO₂ storage capacity in a subterranean formation.

In some embodiments, the surfactant compounds of the invention make it possible to more effectively generate carbon dioxide/water emulsions (also referred to as “foams”) than prior art surfactants, especially at high temperature and high salinity, thereby achieving a larger and/or quicker increase in apparent viscosity, accelerating carbon dioxide storage resources to a given injection area (license area, operating area) and reducing the extent of the CO₂ plume so as not to exceed storage limits.

### BRIEF DESCRIPTION OF THE DRAWINGS

FIG. 1 shows the rise in apparent viscosity (on the Y-axis, in cP) achieved when various surfactant compositions are co-injected with carbon dioxide in a slim tube experiment. The injected volume is on the X-axis, expressed in pore volumes. For more details, see example 1 below.

FIG. 2 shows the final apparent viscosity (on the Y-axis, in cP) achieved when various surfactant compositions are co-injected with carbon dioxide in a slim tube experiment. The temperature applied (in ° C.) is on the X-axis. For more details, see example 2 below.

FIG. 3 shows the solubility of aqueous compositions containing a surfactant of the invention, at different temperatures (on the Y-axis, in ° C.), depending on the concentration in sodium chloride (on the X-axis, in mol/L), at pH=8. White hollow circles indicate a clear, dissolved composition, grey circles indicate a hazy, partly dissolved composition, and black solid circles indicate a cloudy, undissolved composition.

FIG. 4 shows the solubility of a surfactant of the invention in a CO₂ phase, at different pressures (on the Y-axis, in bar), depending on temperature (on the X-axis, in ° C.). The square marks indicate the cloud point pressure above which the CO₂ phase is clear, below which the CO₂ phase is cloudy.

FIG. 5 shows the rise in apparent viscosity (on the Y-axis, in cP) achieved when a surfactant composition of the invention in deionized water (A) and in 220 g/L NaCl brine (B) is co-injected with carbon dioxide, respectively, in a slim tube experiment. The injected volume is on the X-axis, expressed in pore volumes. For more details, see example 3 below.

FIG. 6 shows the gas saturation (bar chart, on the left Y-axis, in Sg) and the apparent viscosity (line chart, on the right Y-axis, in cP) during the co-injection of CO₂ and water containing or not containing the surfactant of the invention into a carbonate core. The varying fraction of CO₂ injected during the co-injection is represented on the X-axis. For more details, see example 4 below.

### DESCRIPTION OF EMBODIMENTS

The invention will now be described in more detail without limitation in the following description.

### Surfactant Compounds of Formula (I)

The invention relies on the use of at least one surfactant which is a compound of formula (I):

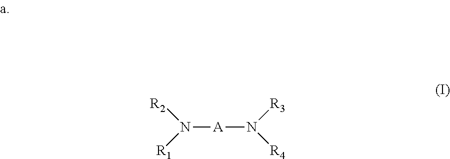

in storing carbon dioxide in a subterranean formation which does not contain any hydrocarbons. In this formula, R₁, R₂, R₃, and R₄ each are independently a hydrogen atom or an alkyl group, A is an alkylene group, and the total number of carbon atoms in the surfactant compound of formula (I) is from 10 to 24.

Each alkyl group in the compound can be linear or branched.

The alkylene group A can be linear or branched and is preferably linear.

The alkyl and alkylene groups are non-substituted. Therefore, the alkyl groups are of the generic formula —CₙH₂ₙ₊₁, where n is an integer, and the alkylene groups A have the formula —CₙH₂ₙ—, where n is an integer.

According to some embodiments, the total number of carbon atoms is 11, or 12, or 13, or 14, or 15, or 16, or 17, or 18, or 19, or 20, or 21, or 22, or 23, or 24. Preferred ranges of carbon atoms are from 15 to 23, 15 to 22, 15 to 20, or 16 to 20, preferably from 16 to 19, and more preferably from 17 to 19.

In some embodiments, the group A may comprise 1 carbon atom, or 2 carbon atoms, or 3 carbon atoms, or 4 carbon atoms, or 5 carbon atoms, or 6 carbon atoms. Number of carbon atoms of 1 to 5 and 2 to 4 are preferred. More preferably, A is —C₃H₆—.

In some embodiments, at least one of R₁, R₂, R₃ and R₄ is a hydrogen atom. Preferably, only one among R₁, R₂, R₃ and R₄ is a hydrogen atom, and the other three are alkyl groups. In such a case, the compound is a diamine compound comprising both a secondary amine function and a tertiary amine function.

The alkyl groups among R₁, R₂, R₃ and R₄ can be linear and/or branched. According to some preferred embodiments, one (and only one) of the alkyl groups among R₁, R₂, R₃ and R₄ is branched. According to other preferred embodiments, all the alkyl groups among R₁, R₂, R₃ and R₄ are linear.

Preferably, one and only one among R₁, R₂, R₃ and R₄ is a hydrogen atom. Therefore, in some preferred embodiments, one and only one of R₁, R₂, R₃ and R₄ is a hydrogen atom and one and only one of R₁, R₂, R₃ and R₄ is a branched alkyl group. In other preferred embodiments, one and only one of R₁, R₂, R₃ and R₄ is a hydrogen atom and the other three of R₁, R₂, R₃ and R₄ are linear alkyl groups.

Preferably, one (and only one) of R₁, R₂, R₃ and R₄ is an alkyl group having a relatively long carbon chain, i.e. comprises at least 6 carbon atoms. The long chain alkyl group preferably comprises at least 7, or at least 8, or at least 9, or at least 10, or at least 11, or at least 12 carbon atoms. Preferred numbers of carbon atoms for this group may range from 8 to 16, or from 10 to 16, or from 11 to 15, or from 12 to 14.

Alternatively, two of R₁, R₂, R₃ and R₄ are alkyl groups having a relatively long carbon chain (i.e. containing at least 6 carbon atoms, possibly at least 7 carbon atoms or at least 8 carbon atoms). In this case, the long chain alkyl groups are preferably geminal, i.e. they can be R₁ and R₂, or R₃ and R₄.

Preferably, the other groups among R₁, R₂, R₃ and R₄ are hydrogen atoms or short chain alkyl groups, i.e. alkyl groups comprising 1 to 3 carbon atoms, preferably 1 to 2 carbon atoms, and most preferably a single carbon atom (i.e. methyl groups).

In one preferred embodiment, one among R₁, R₂, R₃ and R₄ is a hydrogen atom, one among R₁, R₂, R₃ and R₄ is a long chain alkyl group as defined above, and the other two among R₁, R₂, R₃ and R₄ are short chain alkyl groups as defined above, and more preferably methyl groups.

In another preferred embodiment, two among R₁, R₂, R₃ and R₄ are long chain alkyl groups as defined above, and the other two among R₁, R₂, R₃ and R₄ are short chain alkyl groups as defined above, and more preferably methyl groups.

Examples of preferred compounds of formula (I) are those listed in the table below:

| Compound No. | A | R₁ | R₂ | R₃ | R₄ |
|---|---|---|---|---|---|
| 1 | C₃H₆ | octyl | hydrogen | methyl | methyl |
| 2 | C₃H₆ | nonyl | hydrogen | methyl | methyl |
| 3 | C₃H₆ | decyl | hydrogen | methyl | methyl |
| 4 | C₃H₆ | undecyl | hydrogen | methyl | methyl |
| 5 | C₃H₆ | dodecyl | hydrogen | methyl | methyl |
| 6 | C₃H₆ | tridecyl | hydrogen | methyl | methyl |
| 7 | C₃H₆ | tetradecyl | hydrogen | methyl | methyl |
| 8 | C₃H₆ | pentadecyl | hydrogen | methyl | methyl |
| 9 | C₃H₆ | hexadecyl | hydrogen | methyl | methyl |
| 10 | C₃H₆ | 2,2-diethyloctyl | hydrogen | methyl | methyl |
| 11 | C₃H₆ | octyl | methyl | methyl | methyl |
| 12 | C₃H₆ | nonyl | methyl | methyl | methyl |
| 13 | C₃H₆ | decyl | methyl | methyl | methyl |
| 14 | C₃H₆ | undecyl | methyl | methyl | methyl |
| 15 | C₃H₆ | dodecyl | methyl | methyl | methyl |
| 16 | C₃H₆ | tridecyl | methyl | methyl | methyl |
| 17 | C₃H₆ | tetradecyl | methyl | methyl | methyl |
| 18 | C₃H₆ | pentadecyl | methyl | methyl | methyl |
| 19 | C₃H₆ | 2,2-diethyloctyl | methyl | methyl | methyl |

### CO₂ Storage Process

According to the invention, the above surfactant is used in the context of CO₂ storage in a subterranean formation which does not contain any hydrocarbons. The term “does not contain (or not containing) any hydrocarbons” herein typically means that at most only a trace amount of hydrocarbon is present, and preferably, no detectable amount of hydrocarbon is present in the area where CO₂ is injected and stored. The subterranean formation may be a water-bearing subterranean formation, notably of clastic or carbonate nature, for example, an aquifer, in particular a saline aquifer.

Water within the subterranean formation may have a salinity of 0 to 200 or even 250 g/L, preferably of 100 to 200 or 250 g/L, and more preferably of 150 to 200 or 250 g/L. Salinity is defined herein as the total concentration of dissolved inorganic salts in water, including e.g. NaCl, CaCl₂), MgCl₂, Na₂SO₄, NaBr, NaNO₃ and any other inorganic salts.

The temperature within the subterranean formation may range from 5 to 140° C., 10 to 140° C., 20 to 140° C., 25 to 140° C., preferably from 60 to 140° C., more preferably from 80 to 140° C. and even more preferably from 100 to 120° C.

The permeability of at least a portion of the subterranean formation may range from 5 to 5000 md, preferably from 10 to 5000 md, more preferably from 50 to 5000 md, even more preferably from 100 to 5000 md, and further more preferably from 500 to 5000 md, as estimated by well log.

The process may comprise injecting the surfactant of formula (I) of the invention and injecting carbon dioxide (preferably in the liquid state or more preferably in the supercritical state) into the subterranean formation not containing any hydrocarbons.

The injection of the surfactant and carbon dioxide, and optionally water (described in detail below) is preferably performed via one or several injecting wells. In some embodiments, the injection well(s) may comprise a pipeline for injecting the surfactant, and the pipeline may be connected to a dosimetric pump.

The surfactant and carbon dioxide may be injected simultaneously, be it via different injection wells or via the same injection well(s). In the latter case, they can be injected via distinct inlets within a same injection well or via the same inlet.

In some variations, the surfactant and carbon dioxide are injected as one composition. Specifically, the process may further comprise a step of premixing the surfactant and carbon dioxide in the liquid state or preferably in the supercritical state to make a CO₂-surfactant composition, and injecting the CO₂-surfactant composition into the subterranean formation via the same inlet. The “CO₂-surfactant composition” herein means a composition in which the surfactant is dissolved in the carbon dioxide in the liquid state or preferably in the supercritical state.

In this case, the transport of the surfactant may be provided by the CO₂ itself, reducing the risk of the surfactant to be diluted by water present in the subterranean formation. Furthermore, since the partitioning of the surfactant between the water present in the subterranean formation and CO₂ may be limited to the contact zones of these two phases, the surfactant consumption can be reduced.

In addition, any preferential path for CO₂ (and filled by water present in the subterranean formation) may be prioritized for the generation of an emulsion and can be ‘plugged’ by the emulsion. This may result in the distribution from the favorable zones for the CO₂ migration towards the less favorable zones (by, for example, gravitational effect), and the displacement of the water present in the subterranean formation by the CO₂ may be homogenized.

Preferably, after the CO₂-surfactant composition is injected into the subterranean formation, carbon dioxide without a surfactant may be further injected into the subterranean formation.

In some embodiments, the surfactant and carbon dioxide are injected separately into the subterranean formation. In this case, the surfactant may be an aqueous solution in water or brine, for example. In particular, separate steps of the surfactant solution injection and carbon dioxide injection can be provided.

In the process of the invention, no additional water is preferably injected into the subterranean formation. For example, the CO₂-surfactant composition may be injected into the subterranean formation, optionally followed by the injection of carbon dioxide without a surfactant, but without any injection of water into the subterranean formation. In this case, the injected CO₂-surfactant composition encounters water present in the subterranean formation, which induces the generation in-situ of a CO₂-water emulsion which spreads in the subterranean formation. The constant or continuous supply of water may not be required, let alone appropriate surface facilities. This can maximize the CO₂ storage capacity and avoid an excessive pressure rise in the reservoir. Alternatively, the process of the invention may further comprise a step of injecting water into the subterranean formation. The surfactant may be dissolved in water or in carbon dioxide. In particular, separate steps, alternating steps or simultaneous steps of injecting water and of injecting carbon dioxide can be provided.

In some embodiments, the surfactant, the carbon dioxide, and the water may be injected as one composition. Specifically, the process may further comprise a step of premixing the surfactant, the carbon dioxide, and the water to make a CO₂-surfactant-water composition, and injecting this CO₂-surfactant-water composition into the subterranean formation via the same inlet(s), although this is generally not preferred due to the high pressure drop generated by the carbon dioxide/water emulsion in the well(s).

Alternatively, the surfactant and the water may be premixed to make a water-surfactant composition, and this water-surfactant composition may be injected into the subterranean formation via the same inlet(s), followed by injection of CO₂ via the same or different well(s). The water-surfactant composition and CO₂ may be injected simultaneously or alternately via, for example, the same well. The surfactant may partition in-situ between the aqueous phase and the CO₂ during various encounters.

Alternatively, as discussed above, the surfactant and the carbon dioxide may be premixed to make a CO₂-surfactant composition, and this CO₂-surfactant composition may be injected into the subterranean formation via the same inlet(s), followed by injection of water via the same or different well(s). The CO₂-surfactant composition and water may be injected simultaneously or alternately via, for example, the same well. The surfactant may partition in-situ between the aqueous phase and the CO₂ during various encounters.

As discussed above, when the transport of the surfactant may be provided by the CO₂ itself, homogenized displacement of water present in the formation (i.e., piston-like displacement) may be assured, and the dilution of the surfactant may be alleviated. Furthermore, the surfactant consumption can be reduced since the partitioning of the surfactant may be limited to the contact zones of the aqueous phase and CO₂ phase.

In the invention, the injection of the surfactant composition (CO₂-surfactant composition, water-surfactant composition or CO₂-surfactant-water composition) may be performed at a pressure at the sand face of from 72.9 to 350 bar, preferably 72.9 to 300 bar, more preferably from 100 to 250 bar.

It has been found that the apparent viscosity after the injection of the surfactant composition varies depending on the CO₂ fraction. The target viscosity may be thus achieved by varying the CO₂ fraction, depending on the geomechanical constraints of the formation and the injection strategy (for example, with or without addition of water).

Carbon dioxide/water emulsions which are either generated in situ or premade are preferably characterized by a carbon dioxide/water volume fraction ratio of more than 1. According to some embodiments, the surfactant composition (CO₂-surfactant composition, water-surfactant composition or CO₂-surfactant-water composition) may comprise a single surfactant compound of formula (I).

According to other embodiments, the surfactant composition comprises a plurality of (i.e. at least two) surfactant compounds of formula (I). In particular, the surfactant composition may comprise a statistical distribution of compounds of formula (I), as can be obtained for instance starting from an aquifer. It has been found that mixtures of surfactant compounds of formula (I) may provide better performances in CO₂ storage in the water-bearing subterranean formation than single surfactant compound formulations, due to different individual physicochemical properties of the compounds.

In particular, in some of these embodiments, the surfactant composition comprises a plurality of surfactant compounds of formula (I). In preferred variants, A, R₂, R₃ and R₄ are the same for the plurality of surfactant compounds, and R₁ is a different alkyl group. In more preferred variants, A is C₃H₆, R₂ is H, R₃ and R₄ are methyl groups in the various surfactant compounds of formula (I), while R₁ is a different alkyl group, such as in particular an alkyl group (preferably a linear alkyl group) comprising 8 to 16 carbon atoms or comprising 12 to 14 carbon atoms.

The amount of surfactant compound(s) of formula (I) in the surfactant composition is preferably from 500 to 50,000 ppm, and more preferably from 1,000 to 20,000 ppm (w/v).

The surfactant composition may also comprise one or more additives. Such additives may include additional surfactants (not according to formula (I)), salts, sacrificial agents, mobility control polymers, pH adjustment agents, solvents and mixtures thereof.

Additional surfactants may notably include cationic and/or nonionic surfactants, and for instance ammonium cationic surfactants.

According to some embodiments, the surfactant composition (preferably aqueous, such as water-surfactant composition or CO₂-surfactant-water composition) is a buffered aqueous solution, which makes it possible to more precisely control the physicochemical properties of the surfactant compounds. The pH of the surfactant composition is thus preferably from 4 to 8, more preferably from 5 to 7 and even more preferably from 5.5 to 6.5 or from 6.5 to 7.5.

According to some embodiments, the surfactant composition (preferably aqueous, such as aqueous water-surfactant composition or CO₂-surfactant-water composition) is a brine solution, having a salinity of from 70 to 300 g/L, preferably from 120 to 220 g/L. The brine solution which is used may be extracted form the subterranean formation (aquifer). Alternatively, the surfactant composition (CO₂-surfactant composition) may be injected, without any additional injection of water, and the surfactant composition may encounter a brine within the subterranean formation.

It has been surprisingly found that the solubility of the surfactants of the invention is generally larger in more saline solutions than in less saline solutions. Thus, when water is additionally injected, the solubility of these surfactants can be enhanced by increasing the salinity of the surfactant composition.

This is different to what is usually observed with traditional surfactants used for the preparation of CO₂ foam, the solubility of which decreases with increasing salinity. Thus, traditionally, in order to enhance the solubility of a surfactant in a reservoir having a high salinity, a low salinity aqueous solution is injected to pre-flush the reservoir.

In contrast, the surfactant of the invention exhibits good solubility when injected to a subterranean formation having a high salinity, such as a saline aquifer. When the subterranean formation is non-saline, in order to enhance the solubility of the surfactant of the invention, economic inorganic salts may be added to the surfactant composition of the invention, which is more economic than traditional water purification and pre-flush. The amount of salts in the surfactant composition may be adjusted so that the surfactant is dissolved at a temperature from 5 to 150° C., 20 to 150° C., 40 to 150° C., 60 to 150° C., more preferably from 60 to 140° C., even more preferably from 80 to 130° C. and further more preferably from 100 to 120° C.

Salts which may be present in the (preferably aqueous) surfactant composition notably include sodium chloride, sodium bromide, sodium nitrate, sodium sulfate and combinations thereof. The amount of these salts in the (preferably aqueous) surfactant composition may for instance range from 70 to 300 g/L, preferably from 120 to 220 g/L.

Furthermore, it has been found that the enhancement of the solubility of these surfactants is predominantly related to the anions present in the surfactant composition and is generally relatively insensitive to the cations present in the surfactant composition.

Examples of efficient anions for enhancing the solubility of the surfactants are: nitrate or bromide ions, chloride ions and sulfate ions (ranked from most effective to least effective).

Accordingly, in some embodiments, the (preferably aqueous) surfactant composition of the invention comprises nitrate ions in a molar concentration of from 0.1 to 0.3 M, or from 0.3 to 0.5 M, or from 0.5 to 1 M, or from 1 to 1.5 M, or of more than 1.5 M.

In other embodiments, the (preferably aqueous) surfactant composition of the invention comprises bromide ions in a molar concentration of from 0.1 to 0.3 M, or from 0.3 to 0.5 M, or from 0.5 to 1 M, or from 1 to 1.5 M, or of more than 1.5 M.

In other embodiments, the (preferably aqueous) surfactant composition of the invention comprises chloride ions in a molar concentration of from 0.1 to 0.3 M, or from 0.3 to 0.5 M, or from 0.5 to 1 M, or from 1 to 1.5 M, or of more than 1.5 M.

In other embodiments, the (preferably aqueous) surfactant composition of the invention comprises sulfate ions in a molar concentration of from 0.1 to 0.3 M, or from 0.3 to 0.5 M, or from 0.5 to 1 M, or from 1 to 1.5 M, or of more than 1.5 M.

Several of the above anions may be combined together. The total anion concentration in the (preferably aqueous) surfactant composition of the invention may range from 0.1 to 0.3 M, or from 0.3 to 0.5 M, or from 0.5 to 1 M, or from 1 to 1.5 M, or may be more than 1.5 M.

Sodium cations are especially preferred as counterions.

Accordingly, in some embodiments, the surfactant composition comprises sodium nitrate and/or sodium bromide and/or sodium chloride and/or sodium sulfate. The amount of these salts can be adjusted so as to provide the anions molar concentration ranges mentioned above.

In addition, divalent cations (such as calcium or magnesium cations) may be present in the (preferably aqueous) surfactant composition. The weight concentration of these divalent ions in the composition may range from 10 to 50000 ppm. The weight concentration of divalent cations may range from 10 to 100 ppm, or from 100 to 1000 ppm, or from 1000 to 10000 ppm, or from 10000 to 50000 ppm. It has surprisingly been found that a weight concentration of divalent cations of up to approximately 50000 ppm does not affect performance.

The solubility of the surfactants of the invention in CO₂ is believed to be independent of salinity. As shown in the example section below, at low salinity and high temperature, the surfactants of the invention tend to be insoluble in an aqueous phase but soluble in a CO₂ phase.

Controlling or adjusting the salinity of the injected aqueous solution thus makes it possible to control or adjust the solubility of the surfactant and thus to control or adjust the partitioning coefficient between water and carbon dioxide; and to control or adjust the generation and strength of the emulsion. When the salinity is low, the emulsion generated by the surfactant(s) of the invention tends to be relatively weak; and when the salinity is high, the emulsion generated by the surfactant(s) of the invention tends to be relatively strong.

In particular, by injecting carbon dioxide and a low salinity brine into a hot subterranean formation, the surfactants of the invention may be transported in the CO₂ phase, be delivered into the depths of the subterranean formation, and generate an emulsion.

In the process of the present invention, no production well may be required. In other words, it may not be necessary to collect water present in the subterranean formation after the injection of the surfactant, carbon dioxide, and optionally water. Alternatively, water present in the subterranean formation may be collected via at least one production well to improve the CO₂ storage capacity. In this case, the production well(s) may be located at a horizontal distance of from 1 to 100 km, preferably from 10 to 50 km, from the at least one injection well.

In the process of the invention, no CO₂ is collected after the injection of the surfactant, carbon dioxide, and optionally water.

### Preparation of Compounds of Formula (I)

Compounds of formula (I) may be synthesized by reducing compounds having the same formula, except that one of the alkyl groups is replaced by a corresponding acyl group which therefore forms an amide bond with the neighboring nitrogen atom.

By way of example, the preferred compound N¹-dodecyl-N³,N³-dimethylpropane-1,3-diamine can be reduced from dodecylamidopropyl dimethylamine according to the following reaction scheme:

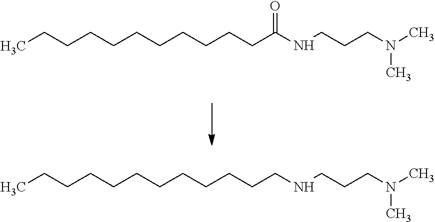

A similar reduction reaction can also be performed starting from a complex mixture, such as cocamidopropyl dimethylamine (which is a mixture of amide compounds, predominantly having a C8-C16 alkyl chain).

The reduction reaction may be performed in the presence of sodium bis(2-methoxyethoxy)aluminumhydride in toluene. Other possible reducing agents include LiAlH₄ and NaBH₄.

The amide starting compounds may be obtained by reacting the corresponding carboxylic acid and amine. For instance dodecylamidopropyl dimethylamine may be obtained by reacting the carboxylic acid of the following formula:

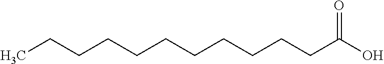

with the diamine of the following formula:

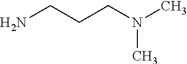

The amidation reaction may be e.g. performed in the presence of a coupling agent such as 2-(1H-benzotriazol-1-yl)-1,1,3,3-tetramethyluronium hexafluorophosphate, of a base such as triethylamine, and in a solvent such as dimethylformamide and/or tetrahydrofurane.

### EXAMPLES

The following examples illustrate the invention without limiting it.

### Example 1—Surfactants According and not According to the Invention

In this example, experiments were conducted within a slim tube packed with sand. The tube length was 25 cm, the tube diameter was 1 cm. The packed sand had a total pore volume of 6.55 mL and a permeability of 16.8 darcy.

Various surfactant compositions were made by dissolving 0.2 wt. % of an individual surfactant compound in brine having a NaCl content of 220 g/L, buffered at pH=6 with a sodium acetate/acetic acid buffer.

Carbon dioxide and the surfactant-brine composition were co-injected into the slim tube via two separate inlets, at a temperature of 25° C. and at a pressure of 150 bar, with a total flow rate of 60 ft/day and a carbon dioxide fraction of 50%.

The pressure drop across the tube was measured and the apparent viscosity was calculated based on Darcy's law. Specifically, the apparent viscosity was obtained according to the following formula: (permeability×pressure gradient)/(volume flow/inlet area of the core (tube)).

The following individual surfactant compounds were tested:
A: no surfactant, pure water (control).
B: nonyl phenol ethoxylate in brine (comparative).
C: bis-(2-hydroxyethyl) coconut alkylamine, marketed by Akzo Nobel as Ethomeen® C12, in brine (comparative).
D: dodecylamidopropyl dimethylamine, in brine (comparative).
E: N¹-dodecyl-N³,N³-dimethylpropane-1,3-diamine, in brine (invention).

In this example, compound D was synthesized from pure chemicals (lauric acid and propanediamine), and compound E was prepared from compound D, according to the process described above.

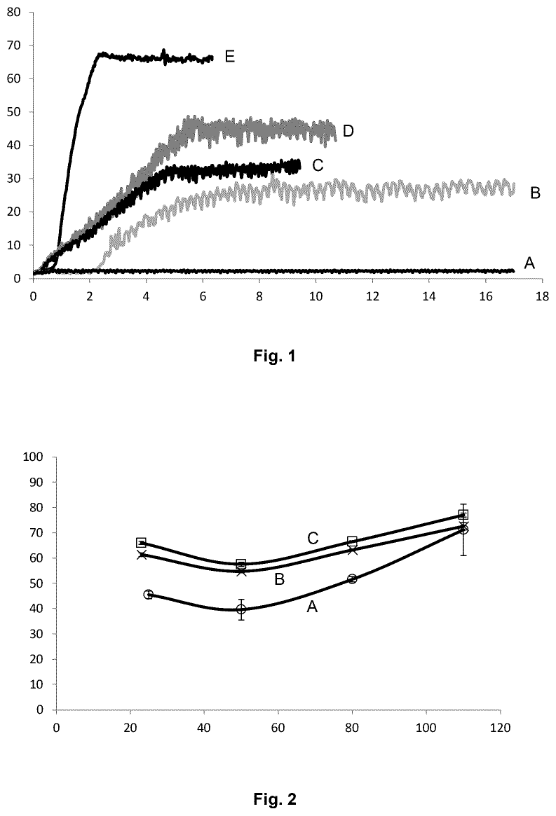

The results of the experiments are shown on FIG. 1. Compound E according to the invention provides a quicker and higher rise in viscosity and is therefore deemed to be more effective than comparative surfactant compounds.

It is believed that the benefit offered by compound E may be even greater at lower permeability and/or higher temperature, i.e. in conditions closer to those of some actual subterranean formations.

In addition to the above, it should be noted that amide compounds such as compound D are not stable at high temperature.

### Example 2—Various Surfactants According to the Invention

In this example, similar experiments to those of example 1 were conducted in a slim tube. In this case, three different surfactant compositions according to the invention were used and tested at different temperatures. All surfactant compositions were made with 0.2 wt. % surfactant in brine having a NaCl content of 220 g/L, buffered at pH=6 with a sodium acetate/acetic acid buffer:
Composition A: N¹-dodecyl-N³,N³-dimethylpropane-1,3-diamine (pure compound E of example 1), in brine.
Composition B: mixture of compounds obtained by reducing cocamidopropyl dimethylamine in brine. The mixture contains not only compound E of example 1 (alkyl chain in C12) but more generally similar compounds having alkyl chains of various lengths (mainly C8-C16 and more particularly C12-C14). This composition was purified by passing in a silica chromatography column to remove organic solvents and by-products in the reducing reaction.
Composition C: same as composition B, except that no purification step was performed.

The results of the experiments are shown on FIG. 2. The data corresponds to the stabilized apparent viscosity after the transient regime (plateaued apparent viscosity) as a function of temperature.

The first observation is that the performance of the surfactant compositions of the invention does not decrease at high temperature, and in some cases even improves at high temperature.

The second observation is that mixtures of compounds according to the invention tend to be more efficient than single compounds.

### Example 3—Effect of Salinity

Several compositions similar to composition C in example 2 were prepared, containing 0.2 wt. % of surfactant in aqueous solutions of salinities at pH=8. The solutions were heated from 25 to 120° C.

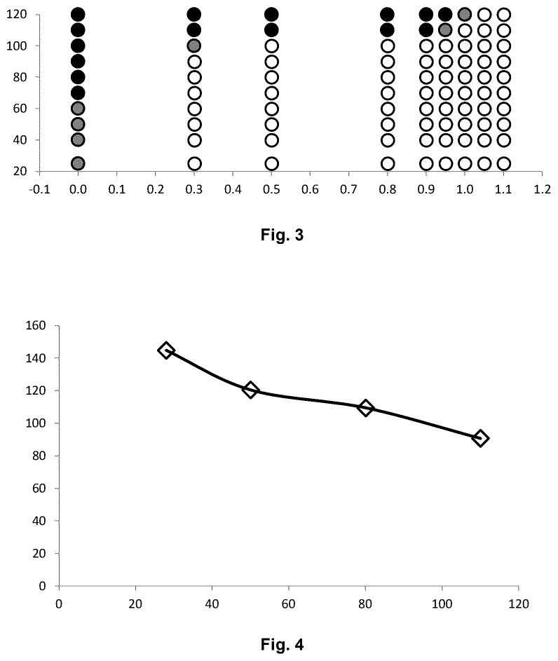

The experimental results are shown in FIG. 3. The surfactant is not soluble in the aqueous phase without any salinity from 25 to 120° C., but gets more and more soluble with increasing salinity.

Additionally, 0.2 wt. % of surfactant was initially dissolved in CO₂ phase at 250 bar and various temperatures. Then, the pressure was slowly decreased by enlarging the volume of the CO₂. When the clear CO₂ phase becomes cloudy, the surfactant is not soluble in CO₂ anymore. This critical pressure is the cloud point pressure. The cloud point pressure at various temperatures was measured.

The experimental results are shown in FIG. 4. The surfactant is dissolved in the CO₂ phase at pressures higher than the cloud point pressure. The solubility of the surfactant in the CO₂ phase is independent of the salinity, and is enhanced by temperature.

Therefore, when the surfactant is injected with CO₂ and aqueous solution having a low salinity, the surfactant preferentially dissolves in the CO₂ at high temperature. The surfactant can thus be transferred into the CO₂ phase in the reservoir, until it meets the high salinity reservoir brine.

Furthermore, 0.2 wt % surfactant compositions having different salinities and having a pH of 6 (adjusted with a sodium acetate/acetic acid buffer) were co-injected with CO₂ into the slim tube of example 1:
Composition A: N¹-dodecyl-N³,N³-dimethylpropane-1,3-diamine in deionized water (salinity=0).
Composition B: N¹-dodecyl-N³,N³-dimethylpropane-1,3-diamine in 220 g/L NaCl brine.

The experimental results are shown in FIG. 5. A strong emulsion can be readily generated in 220 g/L NaCl brine, but cannot in deionized water. Thus, the generation of the strong emulsion can be controlled by salinity. The strong emulsion can be generated near the injection well by injecting high salinity brine. And the strong emulsion can be generated far away from the injection well by injecting low salinity brine.

### Example 4—Use of the Surfactant for Improved CO₂ Storage Capacity

In this example, experiments were conducted using a carbonate core. The core was 30.1 cm long, having a diameter of 3.8 cm, a porosity of 28%, permeability of 130 md.

A surfactant-water composition was prepared by dissolving 0.2 wt. % of a surfactant compound (compound E of Example 1, N¹-dodecyl-N³,N³-dimethylpropane-1,3-diamine) in water.

Carbon dioxide and the surfactant-water composition were co-injected into the carbonate core via two separate inlets, at a temperature of 110° C. and at a pressure of 150 bar, with a total flow rate of 4 ft/day, varying the fraction of carbon dioxide from 50% to 95%. Carbon dioxide and water alone were also co-injected into the carbonate core under the same conditions.

The gas saturation in the core was measured by obtaining a mass balance between what is injected (water+CO2−pump control) and produced water measured by burette (volume) along with a scale (mass).

The apparent viscosity was calculated based on Darcy's law.

The surfactant compound was prepared from the precursor compound, according to the process described above.

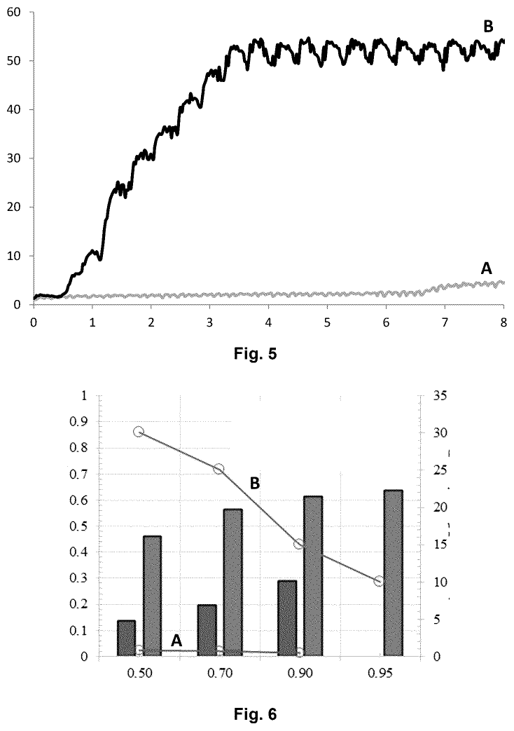

The results of the experiments are shown on FIG. 6. The varying fractions of carbon dioxide (foam quality in fg, CO₂/(CO₂+water)) is represented on the X-axis. This foam quality is representative of the fraction of the front of injection. The gas saturation (in Sg) during the co-injection of CO₂ and water containing or not containing the surfactant is plotted in bar chart on the left Y-axis. The bar in darker grey corresponds to the co-injection of CO₂ and water not containing the surfactant, and the bar in lighter grey to the co-injection of CO₂ and water containing the surfactant. The apparent viscosity (in cP) is plotted in line chart on the right Y-axis. The apparent viscosity A corresponds to the co-injection of CO₂ and water not containing the surfactant while the apparent viscosity B corresponds to the co-injection of CO₂ and water containing the surfactant.

The first observation is that the absence of the surfactant exhibited a low apparent viscosity of the resulting emulsion while the presence of the surfactant resulted in a higher apparent viscosity across the varying CO₂ fractions tested.

The second observation is that, when the surfactant was contained, the apparent viscosity decreased as the CO₂ fraction increased from 50 to 95%.

The third observation is that the gas (CO₂) saturation, which can be considered as an index of CO₂ storage capacity, increased by 2-4 fold in the presence of the surfactant at each CO₂ fraction tested compared to the gas saturation in its absence. This indicates that 2-4 times the quantity of the CO₂ was stored in the core due to the injection of the emulsion with the surfactant.

1. A method of storing carbon dioxide in a subterranean formation not containing any hydrocarbons, comprising:
injecting a surfactant into the subterranean formation;
injecting carbon dioxide into the subterranean formation;
wherein the surfactant is a compound of formula (I): 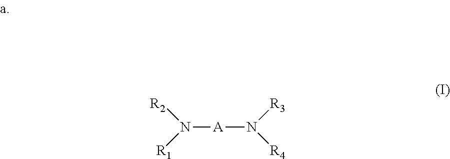
wherein R₁, R₂, R₃, and R₄ are independently a hydrogen atom or an alkyl group, A is an alkylene group, and the total number of carbon atoms in the surfactant compound of formula (I) is from 10 to 24.

2. The method of claim 1, wherein the surfactant and the carbon dioxide are injected simultaneously.

3. The method of claim 1, further comprising a step of premixing the surfactant and the carbon dioxide to make a CO₂-surfactant composition, and comprising injecting the CO₂-surfactant composition into the subterranean formation.

4. The method of claim 3, comprising a step of injecting carbon dioxide without surfactant into the subterranean formation after the step of injecting the CO₂-surfactant composition into the subterranean formation.

5. The method of claim 1, wherein no water is injected into the subterranean formation.

6. The method of claim 1, wherein the surfactant and the carbon dioxide are injected separately.

7. The method of claim 1, further comprising a step of injecting water into the subterranean formation.

8-10. (canceled)

11. The method of claim 7, further comprising a step of premixing the surfactant, the carbon dioxide, and the water to make a CO₂-surfactant-water composition, and comprising injecting this CO₂-surfactant-water composition into the subterranean formation.

12. The method of claim 7, further comprising a step of premixing the surfactant and the carbon dioxide to make a CO₂-surfactant composition and comprising injecting this CO₂-surfactant composition into the subterranean formation.

13. The method of claim 12, wherein the step of injecting the CO₂-surfactant composition and the step of injecting the water are carried out alternately.

14. The method of claim 7, further comprising a step of premixing the surfactant and water to make a surfactant-water composition and injecting the surfactant-water composition into the subterranean formation.

15. The method of claim 14, wherein the step of injecting the carbon dioxide and the step of injecting the surfactant-water composition are carried out alternately.

16. (canceled)

17. The method of claim 1, wherein the injecting step(s) is/are carried out via at least one injection well and wherein the injection well comprises a pipeline for injecting the surfactant, the pipeline being connected to a dosimetric pump.

18. (canceled)

19. The method of claim 1, further comprising a step of collecting water present in the subterranean formation, via at least one production well.

20. (canceled)

21. The method of claim 1, which does not comprise a step of collecting water present in the subterranean formation, via at least one production well.

22. (canceled)

23. The method of claim 1, wherein the total number of carbon atoms in the surfactant compound of formula (I) is from 15 to 22.

24-25. (canceled)

26. The method of claim 1, wherein at least one of R₁, R₂, R₃ and R₄ is an alkyl group comprising from 8 to 16 carbon atoms.

27-28. (canceled)

29. The method of claim 1, wherein A comprises 3 carbon atoms, R₁ is an alkyl group comprising from 6 to 16 carbon atoms, R₂ is a hydrogen atom, R₃ is a methyl group and R₄ is a methyl group.

30. The method of claim 29, wherein R₁ is an alkyl group comprising from 10 to 16 carbon atoms.

31. The method of claim 1, wherein the compound of formula (I) is selected from N¹-dodecyl-N³,N³-dimethylpropane-1,3-diamine, N¹-dodecyl-N¹,N³,N³-trimethylpropane-1,3-diamine, N¹-(2,2-diethyloctyl)-N³,N³-dimethylpropane-1,3-diamine, N¹-octyl-N³,N³-dimethylpropane-1,3-diamine, N¹-decyl-N³,N³-dimethylpropane-1,3-diamine, N¹-tetradecyl-N³,N³-dimethylpropane-1,3-diamine, N¹-hexadecyl-N¹,N³,N³-trimethylpropane-1,3-diamine, N¹-heptadecyl-N¹,N³,N³-trimethylpropane-1,3-diamine, N¹-octadecyl-N¹,N³,N³-trimethylpropane-1,3-diamine, and N-dodecyl-1,3-propanediamine.

32-33. (canceled)
